(19) United States
(12) Patent Application Publication
(10) Pub. No.: US 2006/0002426 A1
(43) Pub. Date: Jan. 5, 2006

(54) Header compression negotiation in a telecommunications network using the protocol for carrying authentication for network access (PANA)

(75) Inventor: Lila Madour, Kirkland (CA)

Correspondence Address: ALEX NICOLAESCU;Ericsson Canada Inc., Patent Department (EMC/QM/P), 8400 Decarie Blvd., Town Mount Royal, QC, H4P 2N2, CA

(73) Assignee: Telefonaktiebolaget L M Ericsson (publ)

(21) Appl. No.: 10/986,770

(22) Filed: Nov. 15, 2004

Related U.S. Application Data
(60) Provisional application No. 60/584,160, filed on Jul. 1, 2004.

(51) Int. Cl. H04J 3/18; H04J 3/22; H04J 3/16; H04Q 7/00

(52) U.S. Cl. 370/477; 370/465

(57) ABSTRACT

A method, a telecommunications node, and a Protocol for Carrying Authentication for Network Access (PANA) Authentication Agent (PAA) of an IP-based network such as a CDMA2000 telecommunications network are provided for negotiating packet data header compression mechanisms. A first and second node, which may be, for example, a Packet Data Serving Node (PDSN) and a Mobile Node (MN) are first involved in a discovery phase. Then the PDSN sends a PANA Start-Request message to the MN with a list of supported header compression mechanisms. The MN receives the PANA Start-Request message with the list, and selects one or more supported mechanism from the list. The MN then responds back to the PDSN with the selected one or more header compression mechanisms via a PANA Start-Answer message. The PDSN stores the selection of the header compression mechanisms, authenticates the MN, possibly in combination with an Authentication, Authorization, and Accounting (AAA) server, and if the authentication is successful, allows the start of a data session using the selected header compression mechanism(s).

### PRIORITY STATEMENT UNDER 35 U.S.C. S.119(e) & 37 C.F.R. S.1.78

This non-provisional patent application claims priority based upon the prior U.S. provisional patent application entitled “QSA: PPP Free Operation”, application No. 60/584,160, filed Jul. 1, 2004, in the name of Lila MADOUR.

### BACKGROUND OF THE INVENTION

1. Field of the Invention

The present invention relates to a method and systems for header compression negotiation between two nodes of a telecommunications network.

2. Description of the Related Art

CDMA2000, also known as IMT-CDMA Multi-Carrier or IS-95, is a Code-Division Multiple Access (CDMA) version of the IMT-2000 standard developed by the International Telecommunication Union (ITU). The CDMA2000 standard is a third-generation (3G) mobile wireless technology allowing mobile nodes (e.g. mobile stations, wireless PDAs, etc) to access IP-based high-speed voice and data traffic over the CDMA-based cellular network. CDMA2000 can support mobile data communications at speeds ranging from 144 Kbps to 2 Mbps.

In order to fully recognize the advantages of the present invention, a short description of some technical concepts associated with CDMA2000 IP-based cellular telecommunications networks is required. A typical CDMA2000 network comprises a number of nodes including a plurality of Mobile Nodes (MNs), a plurality of Base Stations (BSs), one or more Packet Control Functions (PCFs) and one or more Packet Data Serving Nodes (PDSNs), or their equivalent. The BSs may be connected to the PCF, which is an entity in the CDMA2000 Radio Access Network (RAN) that controls the transmission of data packets between the BSs and the PDSN. The PCF is in turn connected with the PDSN.

In a CDMA2000 network, the PDSN provides access to the Internet, intranets and applications servers for MNs utilizing the CDMA2000 RAN. Acting as an access gateway, the PDSN provides simple IP and mobile IP access, Foreign Agent (FA) support, and packet transport for virtual private networking. It may also act as a client for an Authorization, Authentication, and Accounting server (AAA) and provides the MNs with a gateway to the IP network.

The AAA server of a CDMA2000 network intelligently controls access to network resources, enforces policies, audits the usage, and provides the information necessary to bill for the services accessed by the MNs. These combined processes are essential for effective network management and security.

In CDMA2000 networks, the Point-to-Point Protocol (PPP) is used for setting up data session between the MNs and the serving PDSN. PPP is a protocol for communication between two nodes using a serial interface. PPP uses the Internet Protocol (IP) and thus it is sometimes considered a member of the TCP/IP suite of protocols. Relative to the Open Systems Interconnection (OSI) reference model, PPP provides layer 2 (data-link layer) service. Essentially, it packages a computer's TCP/IP packets and forwards them to a server where they can actually be put on the Internet. The use of PPP in CDMA2000 networks is defined in the Internet Engineering Task Force (IETF) Request for Comments (RFC) 1661, which is herein included by reference in its entirety, as a link layer protocol between the MN and the PDSN for the establishment of packet data sessions. In CDMA2000 networks, four types of packet data sessions may be established using PPP: Simple IPv4, Mobile IPv4, Simple IPv6 and Mobile IPv6, on which work in still in progress.

Recently, the 3G Partnership Project 2 (3GPP2) has accepted a work item that proposes the elimination of PPP from the CDMA2000 packet data system and its replacement with an IP level signaling protocol for at least the following motivations:
PPP is a very old technology mainly designed for wire-line dial-up services and 3GPP2 is considering upgrading to a better-suited protocol;
High-Level Data Link Control (HDLC) like framing is a processor intensive task: according to a study made by Qualcomm Inc. for broadcast multicast service, HDLC-like framing is 62 times more computational intensive compared to packet based framing, which has been adopted as an option to support broadcast/multicast service in 3GPP2. The MN and the PDSN utilize a processor intensive procedure whereby they parse received data on an octet-by-octet basis for HDLC flags to determine higher layer packet boundaries. This operation could be rather performed at a hardware level. However, this requires a platform hardware to support HDLC, which is typically not the case with current PDSNs; and
PPP is based on peer-to-peer negotiation, which may cause high call setup delays. According to a recent benchmark, the average PPP call setup time is about 2.5 seconds, which is inappropriate for most applications used in CDMA2000 networks.

However, there is no other existing IETF-based protocol that provides all the capabilities of PPP, i.e. link layer negotiation, header compression negotiation, IP address configuration, packet data session termination, and link layer echo test. Other protocols have recently been identified as IP access based protocols that may represent an alternative to PPP, but each one lacks one or more of the capabilities of PPP.

Recently, the IETF has considered using the Protocol for Carrying Authentication for Network Access (PANA) as one of these possible replacements for PPP for setting up data sessions in CDMA2000 networks. PANA involves two entities, a PANA Authentication Client (PAC) in the MN and a PANA Authentication Agent (PAA) in the PDSN (or connected to the PDSN). An Enforcement point (EP) is also used as an Access Router that provides per packet enforcement policies applied on the inbound and outbound traffic of the MN, although in some case the EP may be implemented in the PDSN itself. PANA, as defined today in the IETF draft, is limited to carry Extensible Authentication Protocol (EAP) authentication between the PAC and the AAA through the PAA. Any EAP method can be transported, including the methods that allow bootstrapping for other protocols in the access network for encryption and data integrity, if so required by the operator.

It is known that in most cases access networks require some form of authentication in order to prevent unauthorized usage. In the absence of physical security (and sometimes in addition to it), a higher layer (L2+) access authentication mechanism is needed. Depending on the deployment scenarios, a number of features are expected from the authentication mechanism. For example, support for various authentication methods (e.g., MD5, TLS, SIM, etc.), network roaming, network service provider discovery and selection, separate authentication for access (L1+L2) service provider and Internet Service Provider (ISP, L3), etc. In the absence of a link-layer authentication mechanism that can satisfy these needs, operators are forced to either use non-standard ad-hoc solutions at layers above the link, insert additional shim layers for authentication, or misuse some of the existing protocols in ways that were not intended by design. PANA is proposed to be developed to fill this gap by defining a standard network-layer access authentication protocol. As a network-layer access authentication protocol, PANA can be used over any link-layer that supports IP.

PPP-based authentication could provide some of the required functionality. Nevertheless, using PPP only for authentication is not a good choice, as it incurs additional messaging during the connection setup and extra per-packet processing, and it forces the network topology to a point-to-point model. Aside from resistance to incorporating PPP into architecture in absence of any other suitable protocol, there is now an interest in the CDMA2000 community to remove PPP from some of the existing architectures and deployments.

The goal of PANA is to define a protocol that allows clients, such as MNs of a CDMA2000 network, to authenticate themselves to the access network using IP protocols. Such a protocol would allow a client to interact with a AAA infrastructure to gain access without the need to understand the particular AAA infrastructure protocols that are in use at the site. It would also allow such interactions to take place without a link-layer specific mechanism. PANA would be applicable to both multi-access and point-to-point links. It would provide support for various authentication methods, dynamic service provider selection, and roaming clients. Mobile IPv4 developed its own protocols for performing PANA-like functions (e.g., MN-Foreign Agent (FA) Interaction). Mobile IPv6 does not have the equivalent of an FA that would allow the access/visited network to authenticate the MN before allowing access. The PAA can perform the authentication function attributed to the FA in Mobile IPv4, in Mobile IPv6 networks. Work is currently being performed with PANA with the assumption that a PAC is already configured with an IP address before using PANA. This IP address will provide limited reachability to the PAC until it is authenticated with the PAA. Upon successful authentication, the PAC is granted broader network access possibly by either a new IP address assignment, or by enforcement points changing filtering rules for the same IP address.

Conclusively, PANA is being developed into an IP-based protocol that allows a device to authenticate itself with the network (and to a PAA in particular) in order to be granted network access. In order to better understand the use of PANA, a short explanation of the PANA usual terminology may be appropriate:

PANA Session:

A PANA session begins with the initial handshake between the PANA Client (PAC) and the PANA Authentication Agent (PAA), and terminates by an authentication failure, a timeout, or an explicit termination message. A fixed session identifier is maintained throughout a session. A session cannot be shared across multiple physical network interfaces. A distinct PANA session is associated with the device identifiers of PAC and PAA.

Session Identifier:

This identifier is used to uniquely identify a PANA session on the PAA and PAC. It includes an identifier of the PAA, therefore it cannot be shared across multiple PAAs. It is included in PANA messages to bind the message to a specific PANA session. This bi-directional identifier is allocated by the PAA following the initial handshake and freed when the session terminateds.

PANA Security Association:

A PANA security association is a relationship between the PAC and PAA, formed by the sharing of cryptographic keying material and associated context. Security associations are duplex. That is, one security association is needed to protect the bidirectional traffic between the PAC and the PAA.

PANA Client (PAC):

The client side of the protocol that resides in the host device, which is responsible for providing the credentials to prove its identity for network, and which access is to be authorized.

Device Identifier (DI):

The identifier used by the network as a handle to control and police the network access of a client. Depending on the access technology, this identifier might contain any of IP address, link-layer address, switch port number, etc of a connected device.

PANA Authentication Agent (PAA):

The protocol entity in the access network side whose responsibility is to verify the credentials provided by a PAC and grant network access service to the device associated with the client and identified by a DI. Note the authentication and authorization procedure can, according to the EAP model, be also offloaded to the backend AAA infrastructure.

Enforcement Point (EP):

A node on the access network where per-packet enforcement policies (i.e., filters) are applied on the inbound and outbound traffic of client devices. Information such as the DI and (optionally) cryptographic keys are provided by the PAA per client for constructing filters on the EP.

Network Access Provider (NAP):

A service provider that provides physical and link-layer connectivity to an access network it manages.

AAA-Key:

A key derived by the EAP peer and EAP server and transported to the authenticator.

In its current form, PANA lacks capabilities for insuring a proper alternative to PPP for the setup of data session in CFDMA2000 networks. For example, PANA does not define mechanisms and functions currently provided by PPP, such as the negotiation of header compression mechanisms between an MN and the serving PDSN. Consequently, PANA as defined in IETF today is not sufficient, and additional capabilities, are required to convert it from just a transport mechanism for EAP packets into a suitable IP access protocol.

In CDMA2000 cellular networks, like in other types of cellular networks, due to the limited bandwidth available over the air interface, data packets sent over the cellular links benefit considerably from data packets header compression (called herein header compression).

An exemplary header compression scheme is ROHC (Robust Header Compression), which performs well over links with high error rates and long roundtrip times. Good header compression performance typically includes both minimal loss propagation and minimal added delay. In addition to generic TCP (Transfer Control Protocol) and UDP/RTP (User Datagram Protocol/Real Time Protocol) compression, applications of particular interest are voice and low-bandwidth video. ROHC may develop multiple compression schemes, for example, some that are particularly suited to specific link layer technologies.

A CDMA2000 network may use various header compression schemes between the serving PDSN and the MNs. During initial session setup, one or more of these schemes supported by both the PDSN and the MN have to be selected for use for a given data session. Up to now, PPP was used as the protocol of choice for negotiating the header compression mechanism for a CDMA2000 packet data session between an MN and a PDSN. However, it has been noticed that the signalling used in such a PPP-based negotiation was lengthy, thus inducing undue delays in the setup of the data session. On the other hand, although the industry is resolved to use PANA as a means for replacing PPP and performing efficient data session setup for a mobile terminal in a CDMA2000 network, so far no actual call scenarios have been proposed for the negotiation of header compression mechanisms.

Accordingly, it should be readily appreciated that in order to overcome the deficiencies and shortcomings of the existing solutions, it would be advantageous to have a method and system for effectively negotiating the appropriate header compression mechanism between an MN and a PDSN during session setup. The present invention provides such a method and system.

### SUMMARY OF THE INVENTION

In one aspect, the present invention is a method for selecting one or more header compression mechanisms for use in a data session between a first and a second node of a telecommunications network, the method comprising the steps of:
sending from the first node to the second node a first Protocol for Carrying Authentication for Network Access (PANA) message, the first PANA message comprising a list of one or more header compression mechanisms supported by the first node; and
receiving from the second node a second PANA message comprising at least one header compression mechanism selected by the second node from the list of header compression mechanisms for use in the data session.

In another aspect, the present invention is a first telecommunications node for selecting one or more header compression mechanisms for use in a data session between the first telecommunications node and a second telecommunications node of a telecommunications network, the first telecommunications node comprising:
a PANA module acting to send from the first telecommunications node to the second telecommunications node a first PANA message, the first PANA message comprising a list of one or more header compression mechanisms supported by the first node;
wherein the PANA module receives from the second telecommunications node a second PANA message comprising at least one header compression mechanism selected by the second node from the list of header compression mechanisms for use in the data session.

In yet another aspect, the present invention is a PANA Authentication Agent (PAA) capable of sending to a PANA Authentication Client (PAC) a PANA Start-Answer message comprising a list of one or more header compression mechanisms supported by a node associated with the PAA, wherein the PAA receives back from the PAC a PANA Start-Answer message comprising at least one header compression mechanism selected by a node associated with the PAA from the list of header compression mechanisms for use in a data session with the node associated with the PAA.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a nodal operation and signal flow diagram representing an exemplary CDMA2000 cellular telecommunications network implementing the preferred embodiment of the present invention.

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others.

In order to alleviate the use of Point-to-Point Protocol (PPP) in Code Division Multiple Access 2000 (CDMA2000) networks, the present invention proposes to replace PPP by an IP based protocol for packet data access and Mobile Node (MN) configuration. More precisely, the invention relies on using the Protocol for Carrying. Authentication for Network Access (PANA), with added enhancements and functionalities, in order to allow an effective header compression negotiation between the MN and the PDSN.

To use PANA, a PANA client (PAC) in the MN and a PANA Authentication Agent (PAA) in the serving Packet Data Serving Node (PDSN) are typically required. The PAC and the PAA establish a PANA session, where the MN is authenticated and authorized. Currently PANA does not support header compression negotiation. Therefore, the current invention proposes to enhance PANA with the inclusion of header compression capabilities during the initial PANA-based handshake, i.e., using PANA Start-Request and PANA Start-Answer messages between the serving PDSN and the MN. The PAA of the PDSN includes in a PANA Start-Request the list of the header compression mechanisms it supports, such as for example a list of the supported ROHC profiles (Robust Header Compression) and ECRTP (Enhanced Compress Real Time Protocol) and any other type of supported header compression mechanisms. The MN receives the list of proposed header compression capabilities of the PDSN, and compares the list with its own header compression capabilities, and selects the one(s) that it also supports. It finally returns in a PANA Start-Answer message only those header compression mechanisms it supports from the list.

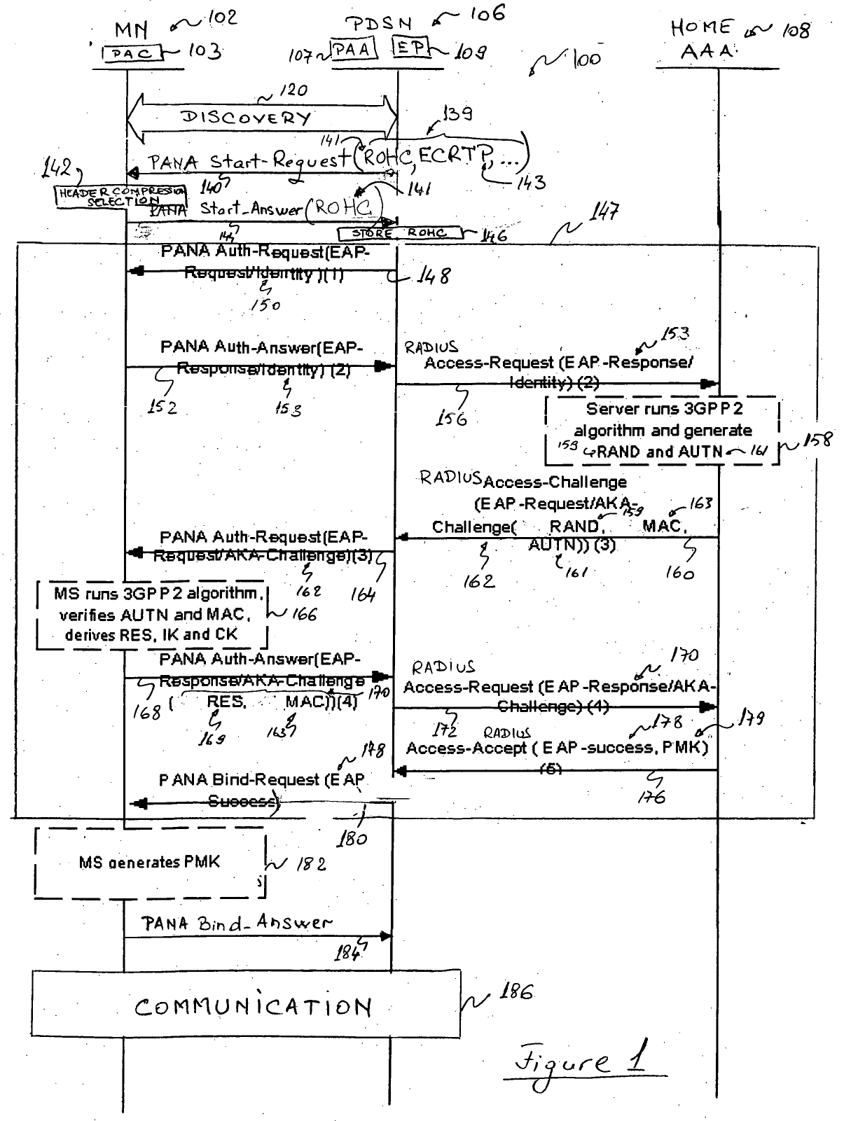

Reference is now made to FIG. 1, which is an exemplary nodal operation and signal flow diagram representing a CDMA2000 telecommunications network 100 implementing the preferred embodiment of the present invention. Shown in FIG. 1, is first a CDMA2000 MN 102 that implements a PAC module 103, which is provided CDMA2000 radio coverage by a Base Station (BS, not shown for simplicity purposes), further connected to a CDMA2000 serving PDSN 106 that comprises a PAA module 107 and an Enforcement Point (EP) module 109. Finally, the PDSN 107 is connected to an Authentication, Authorization, and Accounting (AAA) server 108 responsible for the authentication and authorization of the MNs served by the PDSN 106.

According to the invention, the process starts in action 120 where a PANA discovery phase is performed in order to discover a PAA for the MN, i.e. to provide the MN with the address of the serving PAA. The discovery phase 120 may be performed using a PANA multicast PAA Discovery message sent from the PAA 107 of the PDSN 106 to the PAC 103 of the MN 102, or alternatively using a link layer indication that a new PAC is connected.

Once the discovery phase 120 is completed, the PAA 107 of the PDSN 106 sends to the PAC 103 of the MN 102 a PANA Start Request message 140 with a list 139 of header compression mechanisms supported by the PDSN 106, the list 139 comprising one or more supported header compression mechanisms 141, 143. In the exemplary scenario of FIG. 1, the header compression mechanisms supported by the PDSN 106 are the ROHC 141 and ECRTP 143, although it is understood that other mechanisms may be used as well. Responsive to the receipt of the message 140, the MN 102 compares the received list 139 with its own header compression capabilities, and in action 142 selects from the list one or more mechanisms for use in the yet to be established data session with the PDSN 106, based on its own capabilities. In the present example, it is assumed that the MN 102 selects the ROHC header compression mechanism. Then, the PAC 103 of the MN 102 responds back to the PAA 107 of the PDSN 106 with a PANA Start Answer message 144 comprising the selection of the MN, i.e. the ROHC header compression mechanism 141. The PDSN 106 receives the message 144 with the selected header compression mechanism, which it stores in action 146. Then, before starting an actual data session with the MN 102, the PDSN 106 first performs an authentication procedure of the MN 102, action 147, in order to authenticate and authorize the access of the MN 102 to the resources of the network 100. Such authentication procedure 147 may take various forms, as preferred by the operator of the network 100. For example, the PDSN 106 may use an EAP-based (Extensible Authentication Protocol) authentication method that enables key exchange to allow other protocols to be bootstrapped for securing the data traffic between the PDSN 106 and the MN 102 when CDMA2000 link layer encryption is not used. EAP-AKA (Authentication Key Agreement Protocol) may be used to generate a master session key, which is then sent to the PDSN in the case where the EP (Enforcement Point) is implemented within the PDSN, like in the present example.

The exemplary authentication 147 of the MN 102 with the network 100 may comprise first, a PDSN request message 148 for the user identity of the MN terminal 102, that may comprise a PANA Auth-Request message, which includes parameters 150 indicative of the requested MN identity. The PAC 103 of the MN 102 responds to message 150 with a PANA Auth-Answer message 152 comprising the terminal identity 153 (e.g., the terminal Network Access Identifier (NAI) of the MN 102). Upon receipt of the MN's identity in message 152, the PDSN 106 sends to the AAA server 108 a RADIUS Access-Request message 156 containing an EAP packet with the MN's identity 153. The home AAA server 108 receives the message 156, decides that EAP-AKA authentication is suitable based on the user profile associated with the MN's identity 153, and generates a random value RAND 159 and AUTN value 161 based on the Shared Secret Key (SSK) MN-AAA, which is part of the user profile stored in the AAA 108, and also based on a sequence number, also stored in the AAA, and which is used for AKA authentication vector generation, action 158. The AAA server 108 sends back to the PDSN 106 a RADIUS Access-Challenge message 160 that comprises EAP-AKA Challenge information 162, i.e. the RAND 159, the AUTN 161, and an MAC attribute 163 to protect the integrity of the EAP message. The RADIUS message 160 is received by the PDSN 106, which extracts the EAP-AKA challenge information 162 from the RADIUS message, and sends it further to the MN 102 in a PANA Auth-Request message 164.

The MN 102 verifies the AUTN 161 and the AT_MAC attribute 163, action 166, and if the verification is successful, it generates a response RES attribute 169 that is sent to the PDSN 106 via a PANA Auth-Answer message 168. The purpose of the RES attribute 169 is to allow the home AAA server 108 to authenticate the peer, since the MAC attribute 169 protects the integrity of the EAP packet. The PDSN 106 receives the message 168 and forwards this response (i.e. the AKA Challenge information 170 with the RES attribute 169) via a RADIUS Access-Request message 172 to the AAA server 108.

The home AAA 108 checks the AKA challenge information 170 received in message 172. If the authentication is successful, the AAA server 108 sends a RADIUS Access-Accept message 176 transporting an EAP-Success parameter 178, which informs the PDSN 106 that the MN 102 is successfully authenticated. The AAA server 108 also generates a Pairwise Master Key (PMK) 179 by using, for example, the first 32 bytes of a master key generated based on the user identity, CK (Cipher Key) and IK (Integrity Key), which are session keys generated for the session using the SSK (Shared Secret Key). The AAA 108 sends the PMK parameter 179 to the PDSN 106 in the same message 176. Upon receipt of message 176, the PDSN 106 stores the PMK 179 and uses it to generate an IKE pre-shared key for subsequent IKE exchange.

The PDSN 106, which is informed in message 176 of the successful authentication of the MN 102, then sends a PANA Bind request message 180 comprising the indication EAP Success 178 informing the MN 102 of the successful authentication.

In action 182, the MN 102 also generates the PMK upon receiving the EAP-Success message 180 and the IKE pre-shared key.

Following successful authentication 147, the PDSN 106 and the MN 102 each has a PMK, which they use to generate the IKE pre-shared key using, for example, the following algorithm:
IKE Pre-shared Key=HMAC-SHA-1 (PMK, “IKE-preshared key” |Session ID |Key-ID| EP-address).
Session ID: The value as defined in the PANA protocol and identifies a particular session of a client.
Key-ID: This identifies the PMK within a given PANA session. During the lifetime of the PANA session, there could be multiple EAP re-authentications. As EAP re-authentication changes the PMK, key-ID is used to identify the right PMK.
EP address: This is the IP address of the EP (assumed to be collocated with the PDSN) with which IKE key exchange is being performed.
IKE (v1 or v2) is then exchanged and IPsec SAs are established between the MS and the EP (PDSN).

Finally, in action 184, the MN 102 answers to the PDSN 106 with a PANA Bind Answer message that informs the PDSN 106 of the success of the authentication, and in action 186 packet data communication may take place between the MN 102, and the PDSN 106, wherein data payload is exchanged between the PDSN and the MN with header compression of data packets being performed using the selected header compression mechanisms.

Therefore, with the present invention it becomes possible to optimize the header compression negotiation phase between the PDSN and the MN by only using one signalling round trip instead of multiple round trips like in PPP.

It is to be noted that the various telecommunications nodes and their associated functions described herein, i.e. the PDSN 106, the PAA 107, AAA 108, the MN 102, and the PAC 103 may be implemented using hardware means, software means, or any combination there between, as it is the norm in the art of telecommunications. Also, although the exemplary description of the preferred embodiment of the invention focuses on certain exemplary signalling, it is to be understood that some signalling may vary in the implementation of the invention. For example, the PANA Start Request message 140 may be rather sent from the MN 102 to the PDSN 106, the selection 142 of the header compression mechanism may be rather performed by the PDSN 106, and the PANA Start Answer message 144 may be rather sent from the PDSN 106 to the MN 102. Finally, the implementation of the present invention may not be limited to the exemplary CDMA2000 network, which is described herein, but may be rather viewed as applicable to any IP based network of various protocols.

Based upon the foregoing, it should now be apparent to those of ordinary skills in the art that the present invention provides an advantageous solution, which offers considerable signalling optimization compared to PPP. Although the system and method of the present invention have been described in particular reference to CDMA2000 it should be realized upon reference hereto that the innovative teachings contained herein are not necessarily limited thereto and may be implemented advantageously with with any other access technology that uses header compression using PANA. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for selecting one or more header compression mechanisms for use in a data session between a first and a second node of a telecommunications network, the method comprising the steps of:
a. sending from the first node to the second node a first Protocol for Carrying Authentication for Network Access (PANA) message, the first PANA message comprising a list of one or more header compression mechanisms supported by the first node; and
b. receiving from the second node a second PANA message comprising at least one header compression mechanism selected by the second node from the list of header compression mechanisms for use in the data session.

2. The method claimed in claim 1, wherein:
the first PANA message includes a PANA Start-Request message; and
the second PANA message comprises a PANA Start-Answer message.

3. The method claimed in claim 1, further comprising the steps of:
c. storing in the second node the at least one header compression mechanism selected by the second node.

4. The method claimed in claim 1, wherein:
the first node is a Packet Data Serving Node (PDSN) of a CDMA2000 network; and
the second node is a Mobile Node of the CDMA2000 network.

5. The method claimed in claim 4, further comprising the step of:
c. performing a discovery of the MN prior to step a.

6. A first telecommunications node for selecting one or more header compression mechanisms for use in a data session between the first telecommunications node and a second telecommunications node of a telecommunications network, the first telecommunications node comprising:
a Protocol for Carrying Authentication for Network Access (PANA) module acting to send from the first telecommunications node to the second telecommunications node a first PANA message, the first PANA message comprising a list of one or more header compression mechanisms supported by the first node;
wherein the PANA module receives from the second telecommunications node a second PANA message comprising at least one header compression mechanism selected by the second node from the list of header compression mechanisms for use in the data session.

7. The first telecommunications node claimed in claim 6, wherein:
the first PANA message includes a PANA Start-Request message; and
the second PANA message comprises a PANA Start-Answer message.

8. The first telecommunications node claimed in claim 6, wherein the first telecommunications node stores the at least one header compression mechanism selected by the second node.

9. The first telecommunications node claimed in claim 1, wherein:
the first telecommunications node is a Packet Data Serving Node (PDSN) of a CDMA2000 network; and
the second telecommunications node is a Mobile Node of the CDMA2000 network.

10. A Protocol for Carrying Authentication for Network Access (PANA) Authentication Agent (PAA) capable of sending to a PANA Authentication Client (PAC) a PANA Start-Answer message comprising a list of one or more header compression mechanisms supported by a node associated with the PAA;
wherein the PAA receives back from the PAC a PANA Start-Answer message comprising at least one header compression mechanism selected by a node associated with the PAA from the list of header compression mechanisms for use in a data session with the node associated with the PAA.
